(19) United States
(12) Patent Application Publication
(10) Pub. No.: US 2010/0093359 A1
(43) Pub. Date: Apr. 15, 2010

(54) METHODS AND APPARATUS FOR ENCAPSULATING FEMTOCELL TRAFFIC

(76) Inventors: MARK GALLAGHER, Newbury (GB); James Michael Murphy, Alameda, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/578,394

(22) Filed: Oct. 13, 2009

Related U.S. Application Data
(60) Provisional application No. 61/104,989, filed on Oct. 13, 2008.

(51) Int. Cl. H04W 40/00

(52) U.S. Cl. 455/445

(57) ABSTRACT

Apparatus and methods for providing a virtual communication link between a network controller such as a femtocell controller and other entities external to the femtocell network. A femtocell controller can be configured to receive messages (for example, cells or packages) from a plurality of femtocells within the femtocell network and to package those messages for transport in an aggregated manner across an external network that utilizes a protocol different from the femtocell network, creating a virtual circuit or tunnel across that network to the external entity.

### CROSS-REFERENCE TO RELATED APPLICATIONS

This application claims priority from Provisional Application Ser. No. 61/104,989, which was filed on Oct. 13, 2008 and which is hereby incorporated herein by reference in its entirety.

### TECHNICAL FIELD

The present invention relates generally to wireless communications, and more particularly, some embodiments relate to methods and apparatus for femtocell communications.

### DESCRIPTION OF THE RELATED ART

Perhaps the genesis of mobile telephones can be traced back to their predecessors: two-way radios that were regularly used in taxicabs, police cruisers, and other like vehicles. These early radios were of limited use and flexiblity, and typically only provided half-duplex communications. More flexibility was introduced with the transportable telephones, also known as bag phones, which were used as mobile two-way radios, but could also be patched into the telephone network and used as portable phones.

The development of modern cellular technology is credited, in part to Bell Labs, whose engineers and scientists were responsible for such innovations as hexagonal cell transmissions for mobile phones and early developments in cellular telephony. However, Bell Labs was not alone. In 1973, Marty Cooper, the lead engineer of the team at Motorola that developed the handheld mobile phone, made what is believed to be the first public cellular telephone call. The call was placed to Dr. Joel S. Engel, head of research at AT&T's Bell Labs. This early work led to a paradigm shift from two-way radios and car phones to more personal, flexible and portable telephones, now known as mobile or cellular telephones.

Modern cellular communications utilize a series of base stations that relay communications from cellular telephones to other cellular phones and to the Public Switched Telephone Network (PSTN). The antenna towers for the base stations are geographically distributed in a manner so as to provide overlapping cell coverage to the subscriber mobile devices. As mobile devices move through coverage areas they are handed off from one base station to the next to provide mobile coverage.

A femtocell is a cellular base station that typically has a smaller cell coverage area than conventional macro cellular systems. Femtocells are typically intended for use in a home or small business and can be useful to extend the reach of cellular service to within a building, structure or other environment where cellular access would otherwise be limited or unavailable. Multiple femtocells can be controlled by a controller that connects to the service provider networks via a broadband communications link.

The femtocell generally mirrors the functionality of a conventional base station in a smaller form factor for indoor deployment. An example UMTS femtocell can contain a Node B, RNC and GPRS Support Node. However, femtocell applicability is not limited to UMTS, and they can be implemented with other standards, including for example GSM, CDMA2000, TD-SCDMA and WiMAX.

The 3GPP group of mobile operators and equipment vendors has agreed to develop and promote a standardized architecture that includes a standard femtocell protocol and a standard interface between a 3G femtocell and the mobile core network. 3GPP Technical Specification (TS) 25.467 specifies the UTRAN architecture for 3G Home NodeB (HNB). It covers the functions for user equipment (UEs) not supporting Closed Subscriber Groups (CSG) and UEs supporting CSGs. It also covers HNB specific requirements for O&M. The UE Registration Function for HNB provides a means for the HNB to convey UE identification data to the HNB-GW in order to perform access control for the UE in the HNB GW. The UE Registration also informs the HNB-GW of the specific HNB where the UE is located. As noted in TS 25.467, a secure tunnel is established between the HNB and the HNB-GW (via the Security Gateway (SeGW). Accordingly, under these 3GPP specifications, separate tunnels are established for each femtocell, between the femtocell base and its respective core gateways. The HNB wraps or encapsulates the packets and sends them to the HNB-GW, which unwraps the data, performs an address translation and presents the data to the mobile core.

This is analogous to the way in which a computer network uses a tunneling protocol when encapsulate data of a payload protocol into a different delivery protocol for compatibility with a delivery network. Tunneling can allow a payload to be carried over an otherwise incompatible delivery network, and it can provide a secure path through an entrusted network. Tunneling protocols typically operate at a level in the model that is the same as or higher than the payload protocol. Tunneling is generally considered to be different from layered protocol models such as OSI or TCP/IP (for example: HTTP over TCP over IP over PPP over a V.92 modem). Tunneling protocols can take advantage of encryption to transport payloads over the Internet or other public network to provide a VPN-like functionality.

FIG. 1 is a diagram illustrating an example of how tunneling is performed in accordance with the standards-based 3GPP specifications. Referring now to FIG. 1, illustrated are three or more access point base stations 11 (i.e. HNBs) configured to communicate with an MSC (Mobile Switching Center) and/or SGSN (Serving GPRS Support Node) 20 for access to the core network. In accordance with the 3GPP specifications, this communication is done by way of a secure gateway 12 and HNB gateway 14. In accordance with the specification, each base station 11 establishes a tunnel 17 with secure gateway 12. Particularly, the virtual tunnel 19 is created across a network such as, for example, an IP network 24. This tunnel 19 is created between the access point base station 11 and HNB gateway 14 via secure gateway 12. HNB gateway 14 establishes a connecting tunnel 15 between HNB gateway 14 and MSC or SGSN 20 for access to the mobile core network.

As this illustrates, tunneling is used to create a virtual tunnel 19 across physical links 21, 23 and shared network 24. This allows communications from each of the cells or access point base stations 11 to be established with secure gateway 12. As this further illustrates, virtual protocol tunnels 17, which include virtual tunnels 19 and 15, are established for each access point base station 11 to be connected to the MSC or SGSN 20. Accordingly, for networks with a large number of access point base stations 11, a large number of virtual protocol tunnels 17 must be established. Accordingly, secure gateway 12, HNB Gateway 14 and MSC/SGSN 20 have to deal with multiple VPN channels.

### BRIEF SUMMARY OF EMBODIMENTS OF THE INVENTION

Embodiments of the present invention are directed toward apparatus and methods for providing a virtual communication link between a network controller such as a femtocell controller and other entities external to the femtocell network. For example, in various embodiments, a femtocell controller is configured to receive messages (for example, cells or packages) from a plurality of femtocells within the femtocell network and to package those messages for transport across and external network that utilizes a protocol different from the femtocell network. By way of further example, messages received at the femtocell controller from femtocells in a femtocell network protocol such as, for example, ATM, can be encapsulated in one or more standard networking protocol wrappers such as MPLS, IPSec and IP protocol wrappers for secure transfer over an IP network to the destination. As one of ordinary skill in the art would appreciate, one example of encapsulation of ATM over MPLS Networks is set forth in Internet Engineering Task Force (IETF) Request for Comment RFC 4717, although other methods or protocols can be used.

So packaged, the original messages can be routed across the IP network for transport to the MSC and/or SGSN or other destination across the network. Accordingly, a virtual circuit or tunnel is created between the femtocell controller and the destination across the IP network. Upon receipt, the destination can unwrap the messages and transfer them to the next destination. In terms of the above example, the MSC or SGSN can unwrap the message to arrive at the original message in the femtocell network protocol and provide that message to the core network for processing. Likewise, traffic in the other direction can be wrapped at the MSC/SGSN and transferred via a virtual tunnel to the femtocell controller. As stated above, the virtual tunnel can be established with other destinations. In addition, as would be apparent to one of ordinary skill in the art after reading this description, the systems and methods described herein are applicable to evolutions of the network components, including evolutions of the MSC/SGSN as they may be improved, changed or renamed from time to time or modified according to the standards and their evolution.

In various embodiments, because the origin of the virtual tunnel is the femtocell controller, traffic can be aggregated at the femtocell controller in a single tunnel created between the femtocell controller and a given destination. That is, the femtocell controller receives messages from a plurality of access points and acts as a single source of routing for those messages to the external destination. Therefore, in some embodiments only one virtual tunnel needs to be created between the femtocell network and a given destination. In one embodiment, fewer tunnels can be used than would otherwise be required if a tunnel were created between each access base station/gateway pair. This can provide an advantage over tunneling between the individual base stations and the external entities, as fewer tunnels are typically needed when the end point is the femtocell controller. This can reduce the complexity and cost of the system.

In one embodiment, a method for establishing a communication tunnel between a femtocell controller connected to a femtocell network and an external entity on a shared network, includes the operations of: the femtocell controller operating with the femtocell network and receiving and aggregating messages across the femtocell network from a plurality of base stations, wherein the messages are received in a first network protocol compatible with the femtocell network; the femtocell controller encapsulating aggregated messages received from the plurality of base stations, wherein encapsulating comprises wrapping each message in a wrapper compatible with a second network protocol of a shared network between the femtocell and the external entity; and the femtocell controller sending the wrapped message to the external entity across the shared network. In some embodiments, the sending comprises the femtocell controller sending the wrapped message to an interim entity and the interim entity resends the message to a destination entity. Further, embodiments include the destination entity de-encapsulating the message received via the tunnel and transferring the message to a further destination. The encapsulating can include a single wrapping or successively wrapping the messages in a plurality of wrappers.

In other embodiments, a femtocell controller can be configured for connection to a femtocell network and further configured to establish a communication tunnel between the femtocell controller and an external entity on a shared network, and the femtocell controller can include: a communication module configured to receive and aggregate messages on the femtocell network from a plurality of base stations, wherein the messages are received in a first network protocol compatible with the femtocell network; and an encapsulation module configured to encapsulate the aggregated messages received from the plurality of base stations, wherein encapsulating comprises wrapping each message in a wrapper compatible with a second network protocol of a shared network between the femtocell and the external entity; wherein the communication module is further configured to send the wrapped message to the external entity across the shared network. The femtocell controller can further include a de-encapsulation module configured to de-encapsulate received messages received from across the shared network, wherein de-encapsulating comprises removing unwrapping received messages from a wrapper that is compatible with the second network protocol of the shared network to obtain an inner message in the first network protocol compatible with the femtocell network. The femtocell controller can be further configured to send the unwrapped messages to their respective base stations on the femtocell network.

In still another embodiment, a femtocell controller is configured for connection to a femtocell network and further configured to establish a communication tunnel between the femtocell controller and an external entity on a shared network, the femtocell controller including: means for receiving and aggregating messages on the femtocell network from a plurality of base stations, wherein the messages are received in a first network protocol compatible with the femtocell network; and means for encapsulating the aggregated messages received from the plurality of base stations, wherein encapsulating comprises wrapping each message in a wrapper compatible with a second network protocol of a shared network between the femtocell and the external entity; wherein the communication module is further configured to send the wrapped message to the external entity across the shared network.

In still a further embodiment, a computer readable medium comprising computer executable instructions stored thereon, which, when executed cause a femtocell controller to establish a communication tunnel between the femtocell controller and an external entity on a shared network, wherein establishing the communication tunnel comprises: receiving and aggregating messages on the femtocell network from a plurality of base stations, wherein the messages are received in a first network protocol compatible with the femtocell network; encapsulating aggregated messages received from the plurality of base stations, wherein encapsulating comprises wrapping each message in a wrapper compatible with a second network protocol of a shared network between the femtocell and the external entity; and sending the wrapped message to the external entity across the shared network.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an example of how tunneling is performed in accordance with the 3GPP specifications.

FIG. 2 is a diagram illustrating a simplified architecture for an example environment in accordance with one embodiment of the invention.

FIG. 3 is a diagram illustrating an example communication system in accordance with one embodiment of the invention.

FIG. 4 is a diagram illustrating an example of tunneling in accordance with one embodiment of the invention.

FIG. 5 is a diagram illustrating an example of data encapsulation in accordance with one embodiment of the invention.

FIG. 6 is a diagram illustrating an example representation of encapsulated message in accordance with one embodiment of the invention.

FIG. 7 is a diagram illustrating an example of encapsulating a message into a transportable format in accordance with one embodiment of the invention.

FIG. 8 is a diagram illustrating an example process for unwrapping a message received that was packaged in accordance with the example of FIG. 7.

FIG. 9 is a diagram illustrating a block diagram for an example wireless access point or base station in accordance with one embodiment of the invention.

FIG. 10 is a diagram illustrating an example architecture for access point controller or femtocell controller in accordance with one embodiment of the invention.

FIG. 11 is a diagram illustrating an example computing module in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for providing a virtual communication link between a network controller such as a femtocell controller and other entities external to the femtocell network such as for example and MSC and/or SGSN. For example, in various embodiments, a femtocell controller is configured to receive messages (for example, cells or packages) from a plurality of femtocells within the femtocell network and to package those messages for transport across and external network that utilizes a protocol different from the femtocell network in representing such aggregated flows.

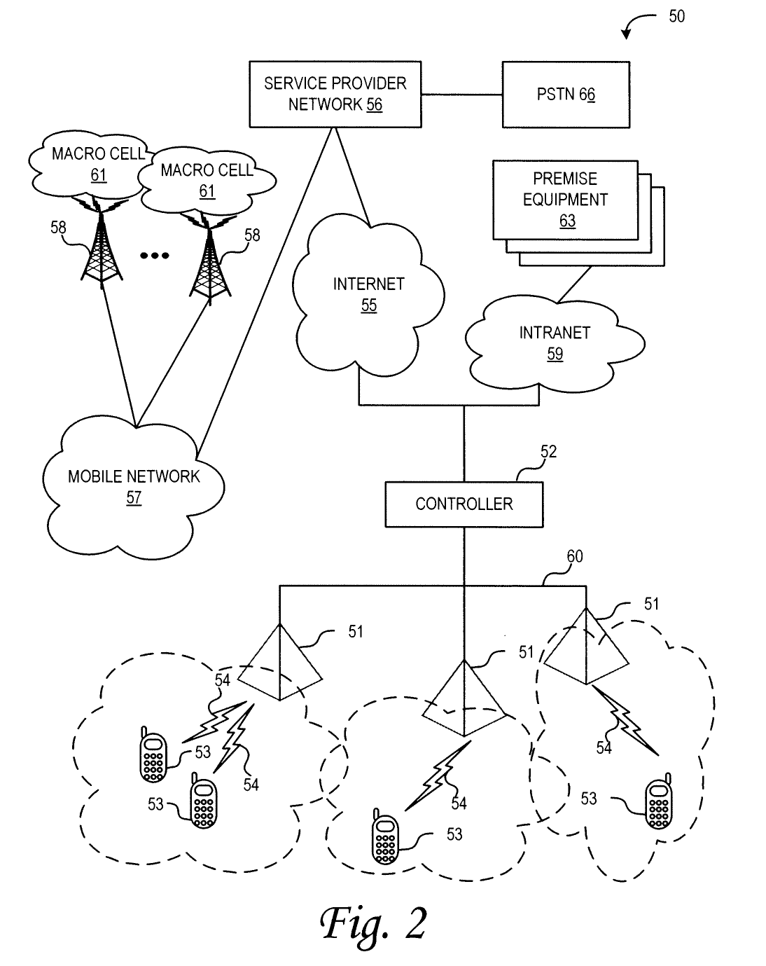

Before describing the invention in detail, it is useful to describe an example environment in which the invention can be implemented. One such example is that of a centrally-controlled femtocell system. FIG. 2 is a diagram illustrating a simplified architecture for such an example environment. In this example environment, one or more femtocells provide cellular coverage for wireless terminals. In some embodiments, wireless terminals can include handsets or other user equipment such as, for example cellular phones, smart phones, laptops, handheld communication devices, handheld computing devices, satellite radios, global positioning systems, PDAs, and/or any other suitable device for communicating over the wireless communication system.

In the illustrated example, femtocells 51 serve as base stations to provide cellular coverage over an air interface 54 to user equipment 53 within their respective areas of coverage. For example, femtocells 51 may be deployed at various locations within a building or other structure to provide cellular coverage to user equipment 53 within the building or structure. This can be advantageous, for example, in large buildings, underground facilities, within aircraft or other transportation vehicles, and within other structures and locations where conventional macro cell coverage is weak or insufficient. Femtocells can also be deployed in environments where it is desirable to augment the capacity of the conventional macrocellular network. Consider the case of a building with a plurality of femtocells distributed therein. In such an environment, the user equipment 53 registers with a femtocell 51 in its range within the building. As the user moves throughout the building, her cellular handset (or other terminal) may be handed off from one femtocell 51 to another to provide suitable coverage for her user equipment 53 as she moves within the building.

In various embodiments, user equipment 53 may comprise, for example, a cellular or mobile handset, a PDA having cellular system access, a laptop with cellular system access for data transmission over cellular systems, or other devices capable of accessing licensed spectrum communications networks for voice or data transmissions. In such applications, femtocells 51 are wireless access points configured to operate within the licensed spectrum to serve as base stations for the user equipment within their range. In other embodiments, femtocells 51 can be implemented as wireless access points for communications with compatible wireless terminals over proprietary or other non-licensed air interface. Although femtocells 51 are illustrated as exclusively wireless access points, embodiments can be implemented wherein femtocells 51 are implemented with wired interfaces to user equipment or a combination of wired and wireless interfaces.

As noted above, femtocell 51 operates as a base station and relays voice and data communication between the user equipment 53 and an end destination. For example, the end destination can be other user equipment within the building (for example, other wireless terminals 53, or other premise equipment 63), a cellular handset operating on a macro cell 61, the PSTN 66, Internet 55 accessible devices and so on.

In the illustrated environment, the femtocells 51 are centrally controlled by a controller 52, sometimes referred to as an access controller. Controller 52 may perform various functions, such as, for example, monitoring operations, coordinating communications among user equipment 53, relaying communications between user equipment 53 and other entities, licensed spectrum allocation, or load balancing amongst the femtocells 51. Femtocells 51 can be connected to access controller 52 via a backhaul 60 which can be implemented using a number of different communication topologies. The connections between the femtocells 51 and the access controller 52 could be dedicated, or the access points and controller could be coupled to one another via a switching network, such as a gigabit Ethernet network, for example.

Femtocells 51 are configured to provide cellular system access by transmitting voice and data transmissions to controller 52, which routes the communications via a packet switched network, such as the Internet 55, via an Intranet 59 or other communication path as appropriate. Accordingly, in some environments controller 52 may comprise a router or switch configured to allow the femtocells 51 to share a network connection and to access networks 55, 59. Controller 52 may also be configured to make routing determinations from among the various entities such that communications with a given wireless terminal 53 may be routed to at least one of the mobile network 57, other femtocells 51 other premise equipment 63 attached to the intranet 59, or other entities as may be accessible by controller 52.

In some examples, the system may further comprise a local intranet 56. For example, the controller 52 and femtocells 51 may be maintained by or integrated with an entity, such as a business or organization that also maintains its own local intranet 56. In some cases, users of the user equipment 53 may desire access to the intranet 56, such as for local data transfers or local voice calls. In such environments, the controller 52 may also mediate these communication activities.

The example environment further comprises a service provider network system 56. For example, the service provider network system may comprise a 2G or 2.5G network such as GSM, EDGE, IS-95, PDC, iDEN, IS-136, 3G based network such as GSM EDGE, UMTS, CDMA2000, DECT, or WiMAX, or any other cellular or telecommunications or other network. Service provider network system 56 further comprises a cellular network 57, that can include mobile switching centers, base station controller and base stations 58 configured to provide macro cell coverage 61 in the environment.

Sometimes, the coverage area of macrocell 61 may overlap with that of femtocells 51, in such cases the controller 52 or the femtocells 51 may provide methods for mitigating interference between the elements. In some instances, user equipment 53 may move from areas covered by femtocells 51 to areas covered by macrocell 61. In these cases, the controller 52 may provide methods for handing off calls from the femtocells 51 to the macrocell 61. In other cases, the network system 56 or other network elements may mediate these transitions.

From time to time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

For example, the innovations described herein often refer to access points and access controllers. As would be apparent to one of ordinary skill in the art after reading this description depending on the nature of the innovation, various embodiments may implement these components as components of a femtocell network (such as the example described with reference to FIG. 2, or as other access point and controller elements (e.g., base stations and base station controllers) in macro cells, other radio access networks, or other like topologies. Additionally, in peer-to-peer environments, coordination and control mechanisms can be assigned to and distributed amongst the various peer elements, or certain peers may be designated as super peers with additional control mechanisms over the other peers. Super peers can be identified, for example, when the network configuration is mapped and network neighbors identified. Accordingly, access point and access controller functions can, in some embodiments, be distributed amongst peers, delegated to super peers, or shared amongst peers and super peers.

For instance, in standards-based 3GPP HSPA systems (UMTS Release 6), the infrastructure element access point or base station is referred to as a “NodeB,” which can be referred to as Home NodeB, or HNB, for femtocell applications, which is known to those of one of ordinary skill in the art familiar with 3GPP systems. The serving NodeB is responsible for allocating a maximum transmit power resource to a wireless terminal (referred to as user equipment, user element or UE in UMTS specifications). In 3GPP LTE (Long Term Evolution) and like systems, uplink power control utilizes a closed-loop scheme around an open-loop point of operation. In 802.16 WiMAX systems, the serving base station is responsible for allocating an OFDMA resource element as well as potentially a maximum transmit power resource to the wireless terminal (called Subscriber Station or SS in the WiMAX specifications). Although many of the examples provided herein are described in terms of a UMTS application, after reading this description one of ordinary skill in the art will understand how these techniques can be implemented in alternative environments.

Although the environments described above can be characterized as a femtocell, macro cellular network or other like topological structure, the methods and apparatus described herein are also well suited to other scenarios, environments and applications, such as a wireless network or a system deployment that has no access controller but comprises distributed wireless access points, which can communicate in a peer-to-peer manner. The innovations described herein are not constrained by the actual choice of wireless protocol technology or network topology, but may be implemented across a wide range of applications as will be appreciated by one of ordinary skill in the art after reading this description.

The innovations described herein are applicable to licensed-spectrum-based cellular technologies in which infrastructure elements such as base stations or access points are provided as entities in the system with some level of coordination. In addition, the innovations are also applicable to unlicensed-spectrum with or without coordinating entities, including, for example, technologies such as WiFi and other technologies that employ peer-to-peer communication techniques.

In hierarchical systems, various functions described herein can be centralized in a control node such as a base station controller or access controller; distributed among like nodes such as base stations or access points; or distributed throughout the hierarchy in base stations and base station controllers. Also, the functions can be included in wireless terminals as well. However, a preferred embodiment relies on base stations or base station controllers to exchange information and instructions and can use wireless terminals in the manner designed for existing networks so as to avoid the need to update or modify existing wireless terminals or run a thin client on the terminals. For example, as certain of the below-described embodiments illustrate, the access points can be configured to instruct the wireless terminals to transmit known signals (such as pilot signals, for example); and can use existing control mechanism such as uplink power control. The systems can also be configured to take measurements of wireless terminal operations to make decisions to avoid, reduce or minimize interference. Other embodiments may place some of these control mechanisms on the wireless terminals or make other distribution of functionality than those examples described herein.

In peer-to-peer environments, coordination and control mechanisms can be assigned to and distributed amongst the various peer elements, or certain peers may be designated as super peers with additional control mechanisms over the other peers. Super peers can be identified, for example, when the network configuration is mapped and network neighbors identified.

Various innovations are described in this document in the context of an exemplary embodiment of the system, such as the example environment described above with reference to FIG. 2, which comprises multiple wireless access points, coupled to an access controller. The connections between the access points and the controller could be dedicated, or the access points and the controller could be coupled to one another via a switching network, such as a gigabit Ethernet network, for example. It should be noted that the innovations are also applicable to wireless system architectures that differ from the example environment and exemplary embodiments described herein, such as a completely distributed system that involves access points that can communicate between themselves in a peer-to-peer manner.

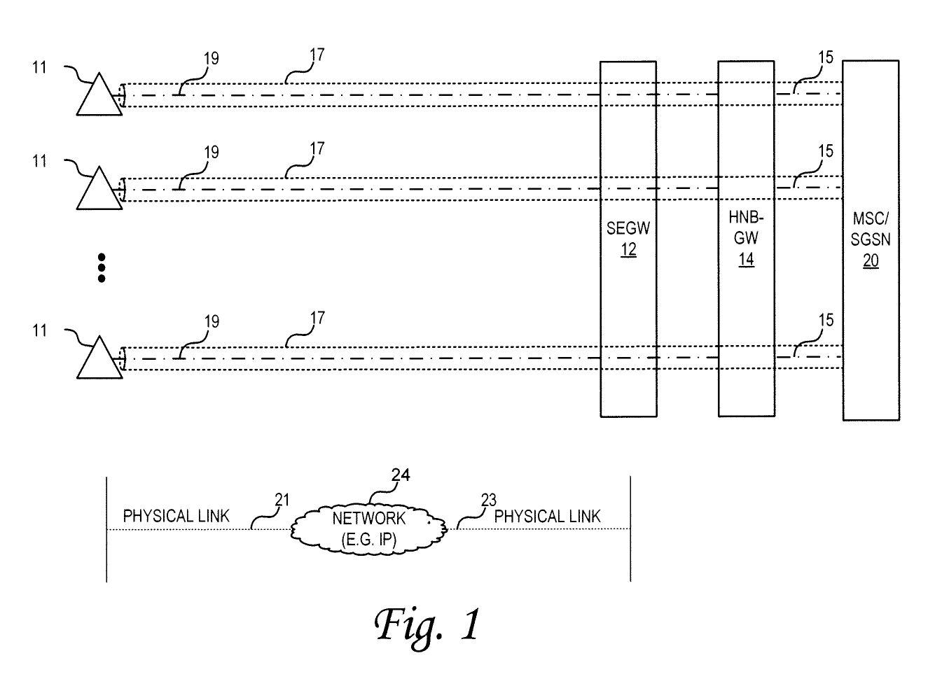

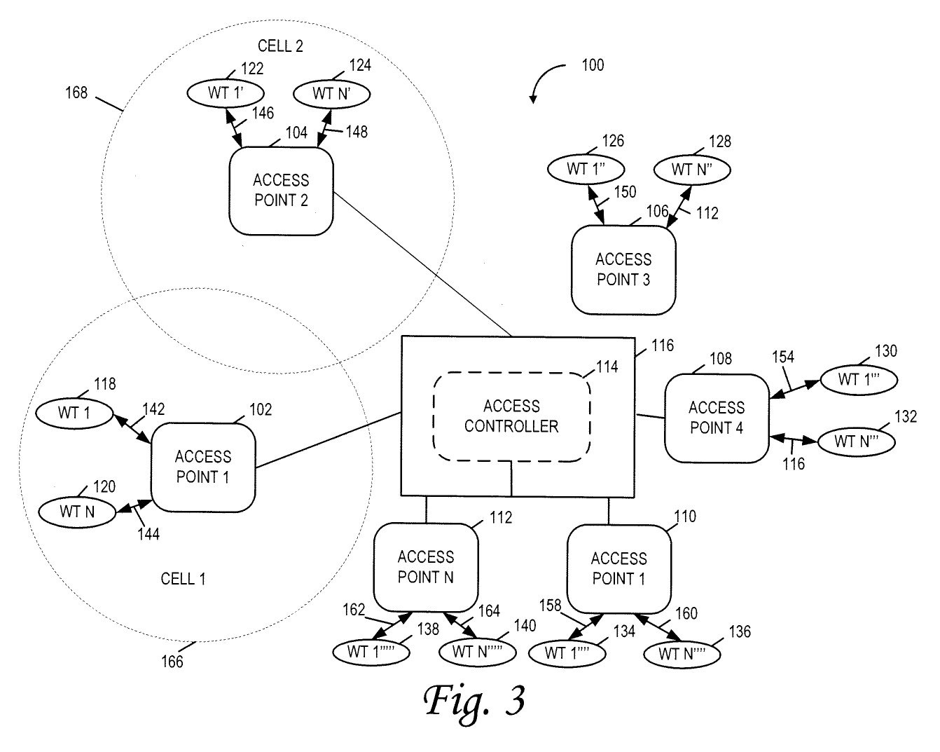

FIG. 3 is a diagram illustrating an example communication system in accordance with one embodiment of the invention. The example illustrated in FIG. 1 depicts a cellular type of architecture, such as a femtocell or other cellular architecture, that includes a single access controller 114 that can be used to control and communicate with a plurality of access points 102, 104, 106, 108, 110 and 112. In this example, the access points 102, 104, 106, 108, 110, 112 are all wireless access points that communicate with a plurality of wireless terminals such as handsets, for example, or other wireless devices. Accordingly, the access points can each define a communication cell, an example of which can include a femtocell. To avoid excessive clutter in the drawings, only two cells 166, 168 are illustrated. Cell 1 166 illustrates an example coverage area for access point 102 and cell 2 168 illustrates an example coverage area for access point 104. As will be appreciated by one of ordinary skill in the art after reading this description, the other access points will also have corresponding areas of cell coverage.

The access points 102, 104, 106, 108, 110, 112 are communicatively coupled to access controller 114 by way of a backhaul 116. For example, in various embodiments, backhaul 116 can be implemented utilizing a communication network such as a packet-switched network. Likewise, alternative communication schemes or topologies can be implemented for backhaul 116. In some embodiments, access controller 114 is configured to coordinate or control at least some of the operations of at least some of the access points 102, 104, 106, 108, 110, 112. Likewise, access controller 114 can serve as a base station to relay communications among the access points 102, 104, 106, 108, 110, 112 (and ultimately their respective wireless terminals), as well as between the access points 102, 104, 106, 108, 110, 112 and their respective wireless terminals and other entities.

The access points 102, 104, 106, 108, 110, 112 are configured to communicate with wireless devices 118 . . . 140 within their respective cells. Such communications can comprise voice and data communications. Examples of wireless devices can include a cellular phone or other wireless terminal. Accordingly, at least some of the wireless terminals can be mobile devices that may move into and out of communication system 100 as well as within communication system 100. In FIG. 1, wireless terminals 118 . . . 120 are coupled to access point 102 via wireless links 142 . . . 144. Likewise, wireless terminals 122 . . . 124 are coupled to access point 104 via wireless links 146 . . . 148, and so on for the other access points 106, 108, 110, 112 as depicted in this example. In some embodiments, the geographical locations of the access points are known to the controller as well as to the access points.

FIG. 3 generally depicts a cellular architecture in which a plurality of cells or access points are distributed to provide coverage cells to the multiple wireless terminals in the coverage areas. The access points are under control and coordination of the access controller. Accordingly, FIG. 1 can represent a number of different communication architectures such as a femtocell architecture and a macro cell architecture. The various embodiments discussed below are described in terms of the components and topology illustrated in FIG. 1. However, after reading these descriptions, it will be apparent to one of ordinary skill in the art how these embodiments can be implemented with other architectures.

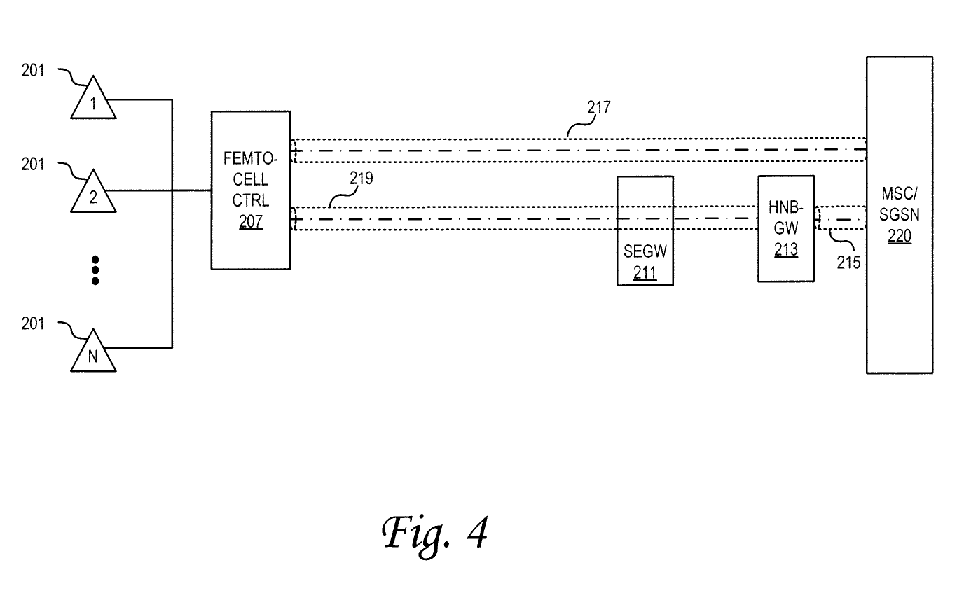

FIG. 4 is a diagram illustrating an example of tunneling in accordance with one embodiment of the invention. Particularly, FIG. 4 illustrates an example of femtocell tunneling in which data for a plurality of access points is aggregated for tunneling via a virtual tunnel between an MSC or SGSN and an access point controller in accordance with one embodiment of the invention. Referring now to FIG. 3, in this example a plurality of N access point base stations (e.g., femtocells) 201 are coupled to a femtocell controller or base station controller 207 via a backhaul network 206. Examples of this femtocell and controller configuration are described above with reference to FIGS. 2 and 3 such as access points 51, controller 52 and backhaul 60 of FIG. 2, or access points 102, 104, 106, 108, 110, 112, access controller 114 and backhaul 116 of FIG. 3.

With continued reference to FIG. 4, in the illustrated example, femtocell controller 207 can be configured to aggregate communications from access point base stations 201 that are received by a backhaul 206. The aggregated communications can be encapsulated for communication to the desired entity such as an MSC or SGSN 220 as illustrated in this example. For example, communications from multiple sources can be encapsulated and placed onto the network, effectively aggregating communications from multiple sources onto a given virtual tunnel or onto multiple tunnels. In the example illustrated in FIG. 4, the data is encapsulated for transmission via a virtual tunnel 219 to secure gateway 211 and HNB gateway 213, then sent over virtual tunnel 215 to the MSC/SGSN 220. This, in effect, creates a virtual tunnel 217 between femtocell controller 207 and MSC/SGSN 220. Accordingly, packages in the femtocell network protocol such as, for example, ATM based communications can be encapsulated within a standard networking protocol and can be further encapsulated in further standard networking protocols for communication via the virtual circuit or tunnel 219. For traffic bound from the core network to wireless terminals in the femtocell networks, the MSC/SGSN 220 can be configured to aggregate traffic bound for femtocell controller 207 and encapsulate the traffic for routing over the virtual circuit 215, 219, (i.e., virtual link 217) in a similar fashion. Likewise, femtocell controller 207 can be configured to unwrap the messages and route them to the appropriate access point base stations 201.

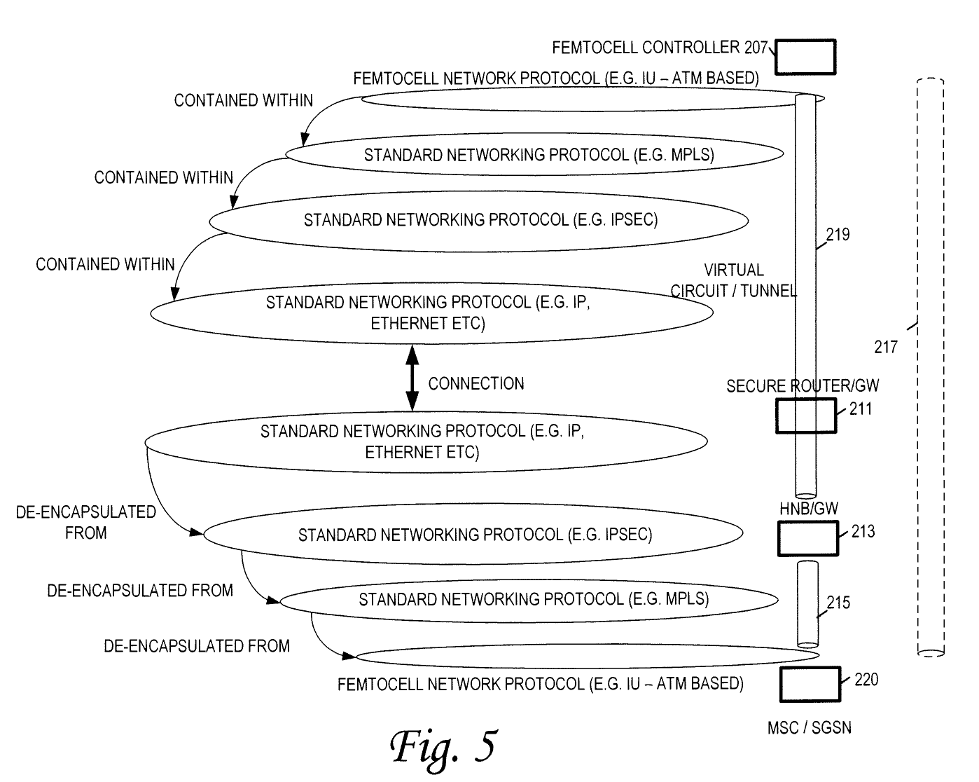

FIG. 5 is a diagram illustrating an example of data encapsulation in accordance with one embodiment of the invention. With reference to FIG. 5, femtocell controller 207 receives data from multiple access point base stations 201 in a femtocell network protocol. For example, this can be an ATM based protocol or other network protocol including other IP transport protocols. As this example illustrates, the aggregated data in the femtocell network protocol is further encapsulated into standard networking protocols. In this example, the ATM based data is encapsulated into a standard network protocol (such as MPLS, for example), which is encapsulated into the standard networking protocol (such as IPSEC, for example), which is encapsulated into a standard networking protocol such as IP or Ethernet for transfer across virtual circuit or tunnel 219. As would be appreciated by one of ordinary skill in the art after reading this description, other levels of encapsulation and encapsulation with other protocols can be accomplished based on the protocol required for the channel or network across which the packets are to be routed. HNB gateway 213 receives the Internet protocol packet and, performing normal routing operations, routes it to the MSC or SGSN 220 via virtual circuit or tunnel 215.

The MSC/SGSN 220 can disassemble or de-capsulate the data, thereby unwrapping it to arrive at the original femtocell network protocol. At this point the MSC/SGSN 220 can appropriately route the data to the core network. This process can also be performed in the opposite direction, to allow data at MSC/SGSN 220 from the core network to be encapsulated for transmission such as via an IP or Ethernet network, for example, and routed to femtocell controller 207.

Depending on the network between femtocell controller 207 and MSC/SGSN 220, additional routers or gateways may be involved in the communication process. Accordingly, encapsulation of the femtocell data into the proper networking protocol can allow this routing across the network to be achieved. As a result of the above described encapsulation during routing, a virtual tunnel 217 is formed between femtocell controller 207 and MSC/SGSN 220.

Because traffic is aggregated from multiple femtocell base stations, embodiments are achieved wherein a single virtual tunnel can be utilized for the aggregated data packages. Accordingly, in some embodiments, a separate virtual tunnel is not required between each access point controller and the MSC, SGSN or other external entity. This can reduce network complexity and the cost of implementation. As a result, MSC/SGSN 220 can be configured to coordinate traffic from fewer virtual tunnels or VPN channels.

The level of aggregation can be determined based on a number of considerations including, the capabilities of the access point controller and the geographic proximity of the access point base stations. Aggregations of 50 to 1 or more, for example, can be achieved reducing overall network complexity. Of course, fewer aggregations can also be accommodated and cost/benefit tradeoffs may drive decisions to aggregate or not aggregate traffic in this manner for a small number of access point controllers in various applications. Accordingly, in various embodiments, femtocell controller 207 is configured to perform an aggregation based on these network considerations. Additionally, femtocell controller 207 can be configured to make intelligent decisions when aggregating and handling data based on characteristics such as, for example, data volume, system load, network bandwidth, quiescent states, power control and quality of service (QoS).

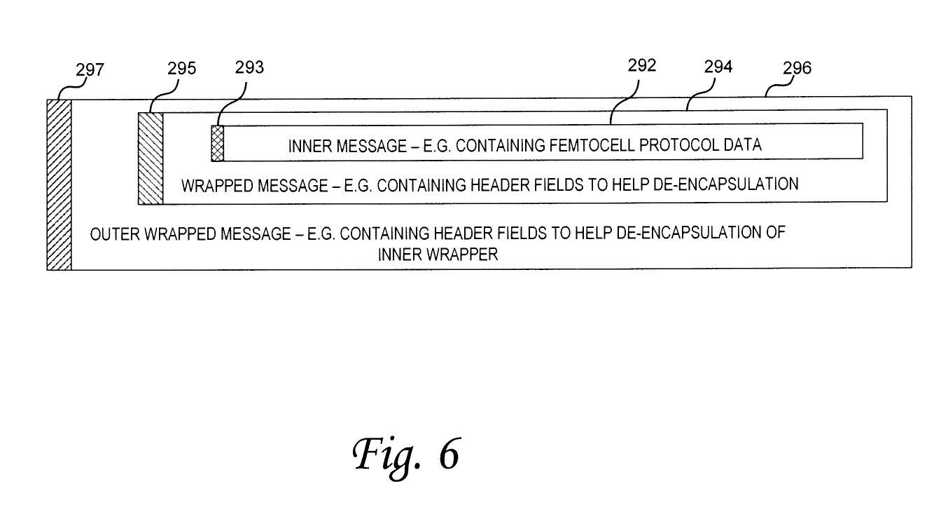

FIG. 6 is a diagram illustrating an example representation of encapsulated message in accordance with one embodiment of the invention. In this example, the original message 292 includes a message header 293 and is encapsulated or wrapped in a first wrapper 294 and a second wrapper 296. Wrapper 294 also includes a header 295 and wrapper 296 includes a header 297. As known to those of ordinary skill in the art, message headers 293, 295, 297 can include conventional header information such as, destination information, routing information, message length information, and other logistical or housekeeping information. Inner message 292 is the data in the femtocell network protocol compatible with the femtocell network. This is in a protocol for messages sent between femtocell base stations (for example, access points 201) and their respective femtocell controller (for example, femtocell controller 207). For example, this can be an ATM-based protocol. Accordingly, prior to wrapping, inner message 292 is in the message format and structure compatible with the backhaul network. For outbound traffic, an encapsulation module can be included in the access point or femtocell controller 207 to wrap message 292 with the appropriate wrapper or wrappers for transfer across the network to the core gateway. For inbound traffic, a de-encapsulation module can be included to unwrap a message package from its wrapper or wrappers to retrieve the original inner message 292 and to distribute inner message 292 to the appropriate access point 201.

ATM, or asynchronous transfer mode, is an example of a network protocol that is useful for transporting real-time video and audio and image data as well as other data and information. It is a packet-based technique that uses asynchronous time division multiplexing of fixed-sized packets. ATM provides data link layer services over OSI layer 1 physical links. ATM cells typically comprise a five-byte header and a 48-byte payload. Payload padding can be used to achieve uniformity in payload length. ATM is different from packet-switched networks such as the Internet or Ethernet, which can use variable sized packets or frames. Accordingly, when a backhaul is implemented as an ATM-based protocol and the connection between the femtocell controller 207 and the MSC/SGSN 220 is via the Internet, the ATM-based cells can be wrapped in an appropriate wrapper or wrappers such that the message can be presented in the standard IP networking protocol for communication. Encryption or secure wrappers can also be utilized.

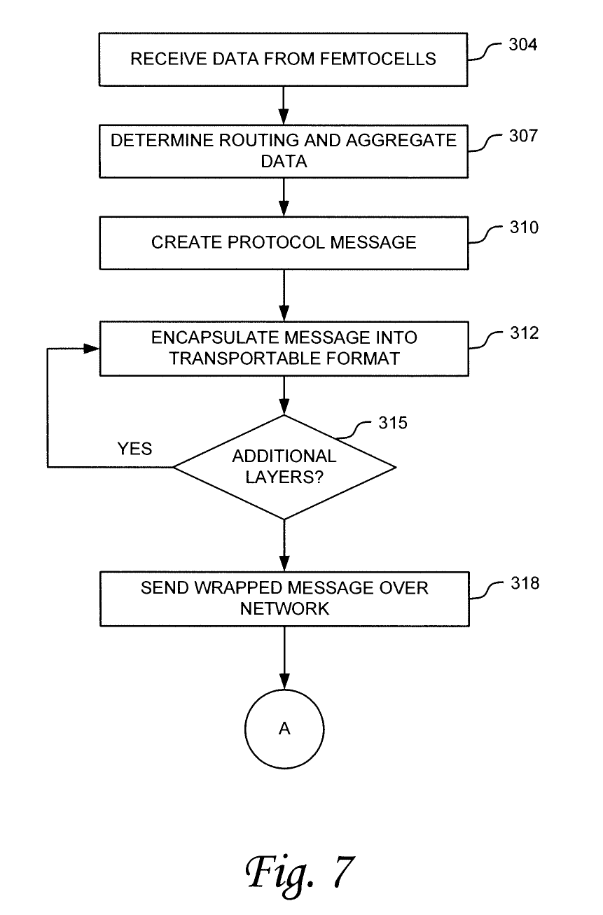

FIG. 7 is a diagram illustrating an example of encapsulating a message into a transportable format in accordance with one embodiment of the invention. Referring now to FIG. 7, in a step 304 data is received at the femtocell controller from one or more femtocells connected thereto. This data is in a format compatible with a network protocol such as, for example, lu or ATM. In a step 307, the femtocell controller determines routing for the message received and aggregates one or more messages for transport via a virtual link to another entity such as an MSC or SGSN or other equipment (examples of which can include service provider network 56 and premise equipment 63 as illustrated in FIG. 2). Aggregation can be determined based on a number of factors including, for example, data volume network loading, equipment loading, our control considerations, QoS considerations and the like. Likewise, data can be aggregated on a destination basis. For example, where data from multiple wireless terminals communicating via the access point base stations is destined to a plurality of different carriers, the data can be aggregated according to carrier and a virtual tunnel established for each of the carriers to which data is destined.

In a step 310, a protocol message is created. The protocol messages received at the controller are an aggregation of messages from the femtocells that are to be subsequently wrapped for transmission across the virtual tunnel. Aggregation can occur, for example, by the femtocell controller directing multiple wrapped messages from a plurality of base stations through a given virtual circuit.

In step 312, the message is encapsulated into a transportable format. For example, an ATM-based message can be wrapped for transfer across an IP network. Where multiple layers of encapsulation are performed, this step can be repeated to achieve the desired level of encapsulation as illustrated by step 315 and flowline 316. In step 318, the wrapped message is transported over the network to its destination. There is neither a minimum nor a maximum number of encapsulation layers or concatenated tunnels required to create the desired virtual tunnel, and the actual numbers will depend on the various protocols utilized from end to end, and the network configuration.

FIG. 7 is described above with reference to encapsulation at a femtocell controller. After reading this description, it will be obvious to one of ordinary skill in the art how this encapsulation process can also be performed at the MSC, SGSN or other entity that is creating a virtual tunnel back to a femtocell controller.

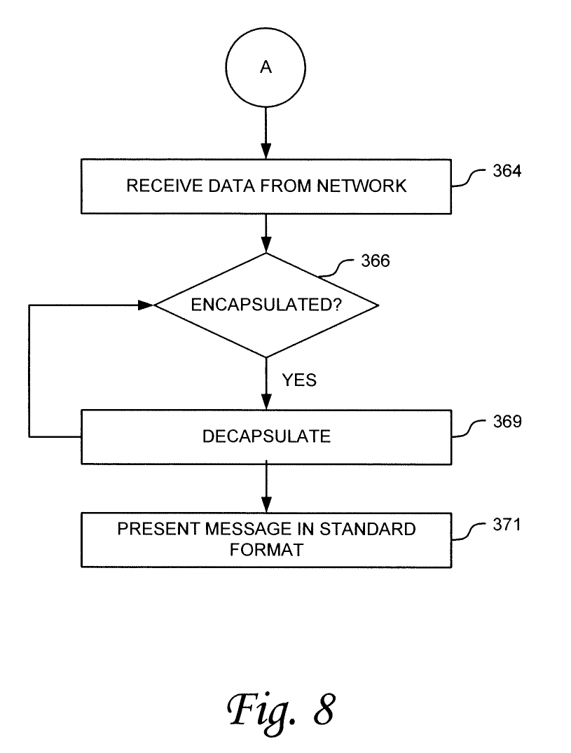

FIG. 8 is a diagram illustrating an example process for unwrapping a message received that was packaged in accordance with the example of FIG. 7. Referring now to FIG. 8, in a step 364 the wrapped data is received from the network. The de-encapsulation module determines whether the data is encapsulated and if so be encapsulates it is illustrated by steps 366 and 369. The encapsulation can be repeated as appropriate to properly unwrap the message to achieve the original message format. Accordingly, in a step 371, the message is presented in its original standard format.

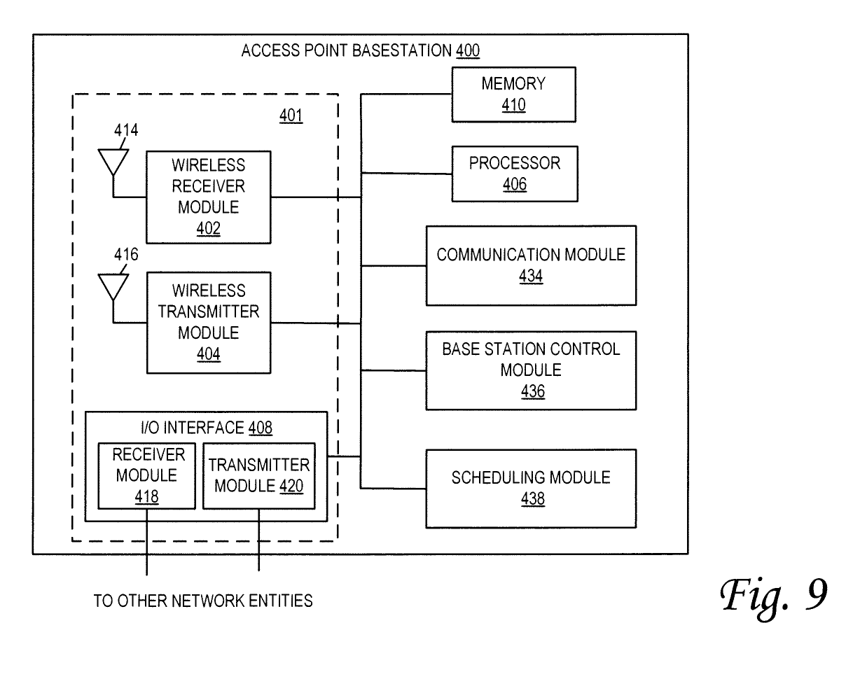

FIG. 9 is a diagram illustrating a block diagram for an example wireless access point or base station in accordance with one embodiment of the invention. In particular, the example architecture illustrated in FIG. 9 shows an embodiment of an access point architecture configured to transmit and receive messages to and from an access point controller over a communication link such as a backhaul, and configured to transmit and receive messages to and from UEs or other wireless terminals.

In this example architecture, the access point 400 includes a communication module 401, a processor 406, and memory 410. These components are communicatively coupled via a bus 412 over which these modules may exchange and share information and other data. Communication module 401 includes wireless receiver module 402, a wireless transmitter module 404, and an I/O interface module 408.

An antenna 416 is coupled to wireless transmitter module 404 and is used by access point 400 to wirelessly transmit downlink radio signals to wireless terminals with which it is connected. These downlink RF signals can include voice and data communications sent to the wireless terminals registered with the access point 400 to allow routine communication operations of the cell. The downlink RF signals can also include control signals such as, for example, uplink power control signals that are sent to registered wireless terminals to allow access point 400 to control the uplink transmit power of the wireless terminals that are communicating with access point 400 as a point of attachment to the cell.

Antenna 414 is included and coupled to wireless receiver module 402 to allow access point 400 to receive signals from various wireless terminals within its reception range. Received signals can include voice and data communications from a wireless terminal in the access point's cell coverage area for routine communication operations. Accordingly, signals such as wireless uplink signals from registered wireless terminals that have a current connection with access point 400 are received. Also, access point 400 typically receives various housekeeping or control signals from wireless terminals such as an uplink pilot signal, for example.

Although two antennas are illustrated in this and other example architectural drawings contained herein, one of ordinary skill in the art will understand that various antenna and antenna configurations can be provided as can different quantities of antennas. For example, transmit and receive functions can be accommodated using a common antenna or antenna structure, or separate antennas or antenna structures can be provided for transmit and receive functions as illustrated. In addition, antenna arrays or other groups of multiple antennas or antenna elements, including combinations of passive and active elements, can be used for the transmit and receive functions.

An I/O interface module 408 is provided in the illustrated example, and can be configured to couple access point 400 to other network nodes. These can include nodes or equipment such as, for example, other access points, and an access controller. In this example architecture, the I/O interface module 408 includes a receiver module 418 and a transmitter module 420. Communications via the I/O interface module can be wired or wireless communications, and the transmitter and receiver contained therein can include line drivers and receivers, radios, antennas or other items, as may be appropriate for the given communication interfaces. Transmitter module 420 is configured to transmit signals that can include voice, data and other communications to the access controller. These are typically sent in a standard network protocol specified for the cellular backhaul.

Receiver module 418 is configured to receive signals from other equipment such as, for example, other access points (in some embodiments, via the access controller), and an access controller. These signals can include voice, data and other communications from the access controller or other equipment. These are typically received in a standard network protocol specified for the cellular backhaul.

Memory 410, can be made up of one or more modules of one or more different types of memory, and in the illustrated example is configured to store data and other information 424 as well as operational instructions such as access point control routines 422. The processor 406, which can be implemented as one or more CPUs or DSPs, for example, is configured to execute instructions or routines and to use the data and information 424 in memory 410 in conjunction with the instructions to control the operation of the access point 400. For example, access point control routines can include instructions to enable processor 406 to perform operations for transferring data between wireless terminals and the access point controller, and for managing communications with and control of wireless terminals.

Accordingly, a communication module 434 can be provided at a femtocell access point to manage and control communications received from other network entities such as a femtocell controller or other access point basestations, and to direct appropriate received communications to their respective destination wireless terminals. Likewise, communication module 434 can be configured to manage received communications from wireless terminals and direct them to their next destination such as, for example to the femtocell controller for transfer to the core network. Communication module 434 can be configured to manage communication of control information sent to and received from wireless terminals. As such, communication module 434 can manage wireless communications such as uplink and downlink communications with wireless terminals as well as wired communications such as those conducted over the Ethernet (or other) backhaul.

A base station control module 436 can be included to control the operation of access point base station 400. For example, they station control module 436 can be configured to implement the features and functionality described above for communicating and transferring information among wireless terminals, other femtocells, in a femtocell controller. A scheduling module 438 can also be included to control transmission scheduling or communication resource allocation. Information that is used by base station control module 436 and scheduling module 430 can also be included in memory 410 such as entries for each active mobile node or wireless terminal, which lists the active sessions conducted by a user and can also include information identifying the wireless terminal used by a user to conduct the sessions.

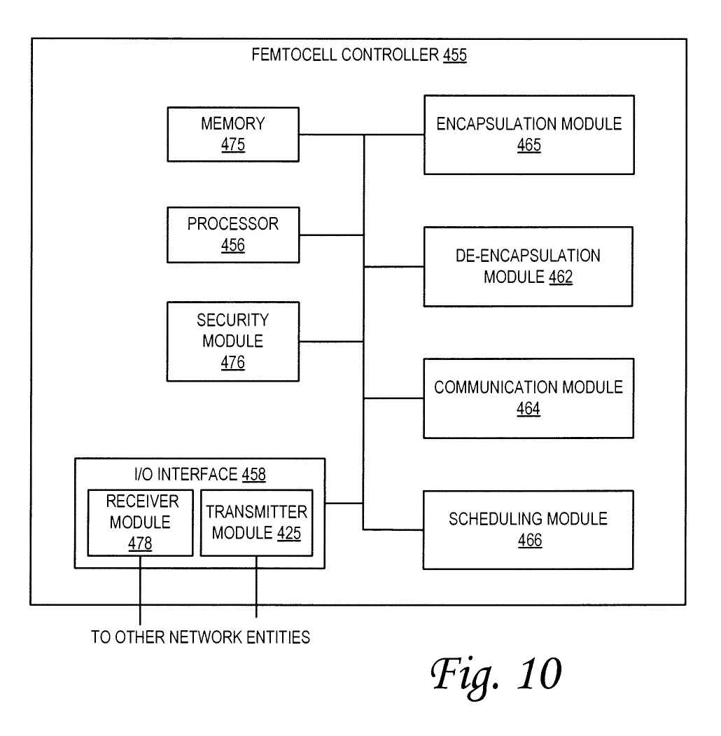

FIG. 10 is a diagram illustrating an example architecture for access point controller or femtocell controller in accordance with one embodiment of the invention. In this example architecture, femtocell controller 455 includes a memory 475, a processor 456 and a security module 476. Memory 475 and processor 456 can be implemented similar to that as described above with reference to FIG. 9. However, of course, memory 475 configured to store instructions data and other information for the operation of femtocell controller 455. Security module 476 can be included in configured to manage security operations for femtocell controller 455.

In the example architecture, femtocell controller 455 includes an encapsulation module 465 and a de-encapsulation module 462 to perform encapsulation and a de-encapsulation of messages. For example, encapsulation module 465 can be configured to accept messages received from wireless terminals in a femtocell network compatible protocol and perform one or more levels of encapsulation to achieve compatibility with a communication network between the femtocell controller 455 and another entity such as, for example, an MSC or SGSN. Likewise, de-encapsulation module 462 can be configured to unwrap messages received from the external network and forward the embedded femtocell network protocol messages to the appropriate femtocell network entity such as a designated access point.

As with the access point base station, femtocell controller 455 can be configured to include a communication module 464 and a scheduling module 466. These modules can be configured to manage and schedule the communications of inbound and outbound traffic of femtocell controller 455. An I/O interface 458 is provided with a receiver module 478 and a transmitter module 425 for communication to other network entities. For example, the femtocell network backhaul indications can be performed by an I/O interface such as I/O interface 458. Likewise, and I/O interface 458 can be provided for communication over the Internet or other communication channel for communications to entities such as an MSC or SGSN. Although one I/O interface 458 is illustrated, one of ordinary skill in the art will understand after reading this description that multiple interfaces, or multiple receivers and transmitters can be provided with the appropriate receivers and drivers compatible with the various networks or communication channels over which femtocell controller 455 communicates.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

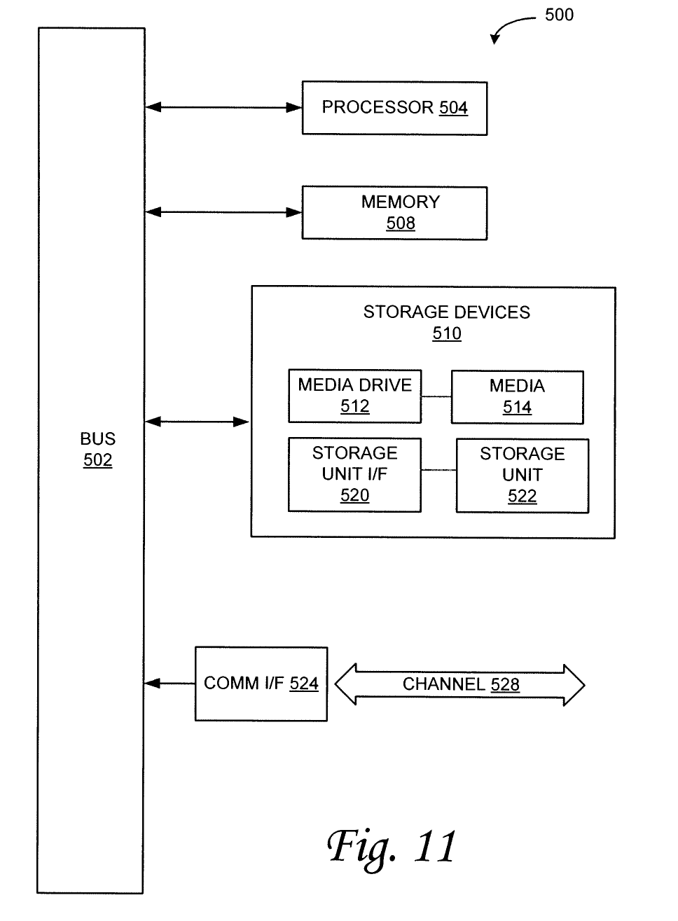

As used herein, the term module can describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 500. After reading this description, it will become apparent to a person skilled in the relevant art how to implement the invention using other computing modules or architectures.

Referring now to FIG. 11, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for establishing a communication tunnel between a femtocell controller connected to a femtocell network and an external entity on a shared network, comprising:
the femtocell controller operating with the femtocell network and receiving and aggregating messages across the femtocell network from a plurality of base stations, wherein the messages are received in a first network protocol compatible with the femtocell network;
the femtocell controller encapsulating aggregated messages received from the plurality of base stations, wherein encapsulating comprises wrapping each message in a wrapper compatible with a second network protocol of a shared network between the femtocell and the external entity; and
the femtocell controller sending the wrapped message to the external entity across the shared network.

2. The method of claim 1, wherein the sending comprises the femtocell controller sending the wrapped message to an interim entity and the interim entity resends the message to a destination entity.

3. The method of claim 1, further comprising the destination entity de-encapsulating the message received via the tunnel and transferring the message to a further destination.

4. The method of claim 1, wherein encapsulating comprises successively wrapping each message in a plurality of wrappers.

5. A femtocell controller configured for connection to a femtocell network and further configured to establish a communication tunnel between the femtocell controller and an external entity on a shared network, the femtocell controller comprising:
a communication module configured to receive and aggregate messages on the femtocell network from a plurality of base stations, wherein the messages are received in a first network protocol compatible with the femtocell network; and
an encapsulation module configured to encapsulate the aggregated messages received from the plurality of base stations, wherein encapsulating comprises wrapping each message in a wrapper compatible with a second network protocol of a shared network between the femtocell and the external entity;
wherein the communication module is further configured to send the wrapped message to the external entity across the shared network.

6. The femtocell controller of claim 1, further comprising a de-encapsulation module configured to de-encapsulate received messages received from across the shared network, wherein de-encapsulating comprises removing unwrapping received messages from a wrapper that is compatible with the second network protocol of the shared network to obtain an inner message in the first network protocol compatible with the femtocell network.

7. The femtocell controller of claim 1 wherein the communication module is further configured to send the unwrapped messages to their respective base stations on the femtocell network.

8. The femtocell controller of claim 1, wherein encapsulating comprises successively wrapping each message in a plurality of wrappers.

9. A femtocell controller configured for connection to a femtocell network and further configured to establish a communication tunnel between the femtocell controller and an external entity on a shared network, the femtocell controller comprising:
means for receiving and aggregating messages on the femtocell network from a plurality of base stations, wherein the messages are received in a first network protocol compatible with the femtocell network; and
means for encapsulating the aggregated messages received from the plurality of base stations, wherein encapsulating comprises wrapping each message in a wrapper compatible with a second network protocol of a shared network between the femtocell and the external entity;
wherein the communication module is further configured to send the wrapped message to the external entity across the shared network.

10. The femtocell controller of claim 9, further comprising means for de-encapsulating received messages received from across the shared network, wherein de-encapsulating comprises removing unwrapping received messages from a wrapper that is compatible with the second network protocol of the shared network to obtain an inner message in the first network protocol compatible with the femtocell network.

11. The femtocell controller of claim 10, further comprising means for sending the unwrapped messages to their respective base stations on the femtocell network.

12. The femtocell controller of claim 9, wherein the means for encapsulating comprises successively wrapping each message in a plurality of wrappers.

13. A computer readable medium comprising computer executable instructions stored thereon, which, when executed cause a femtocell controller to establish a communication tunnel between the femtocell controller and an external entity on a shared network, wherein establishing the communication tunnel comprises:
receiving and aggregating messages on the femtocell network from a plurality of base stations, wherein the messages are received in a first network protocol compatible with the femtocell network;
encapsulating aggregated messages received from the plurality of base stations, wherein encapsulating comprises wrapping each message in a wrapper compatible with a second network protocol of a shared network between the femtocell and the external entity; and
sending the wrapped message to the external entity across the shared network.

14. The computer readable medium of claim 13, wherein the sending comprises the femtocell controller sending the wrapped message to an interim entity and the interim entity resends the message to a destination entity.

15. The computer readable medium of claim 13, wherein establishing the communication tunnel further comprises de-encapsulating received messages received from across the shared network, wherein de-encapsulating comprises removing unwrapping received messages from a wrapper that is compatible with the second network protocol of the shared network to obtain an inner message in the first network protocol compatible with the femtocell network.

16. The computer readable medium of claim 13, wherein establishing the communication tunnel further comprises sending the unwrapped messages to their respective base stations on the femtocell network.

17. The computer readable medium of claim 13, wherein encapsulating comprises successively wrapping each message in a plurality of wrappers.

18. The femtocell controller of claim 1, further comprising a de-encapsulation module configured to de-encapsulate received messages received from across the shared network, wherein de-encapsulating comprises removing unwrapping received messages from a wrapper that is compatible with the second network protocol of the shared network to obtain an inner message in the first network protocol compatible with the femtocell network.

19. The femtocell controller of claim 1 wherein the communication module is further configured to send the unwrapped messages to their respective base stations on the femtocell network.

20. The femtocell controller of claim 1, wherein encapsulating comprises successively wrapping each message in a plurality of wrappers.
